(19) United States
(12) Patent Application Publication
(10) Pub. No.: US 2015/0252306 A1
(43) Pub. Date: Sep. 10, 2015

(54) COMPOSITIONS COMPRISING A PUNGENT AGENT

(71) Applicant: The Procter & Gamble Company, Cincinnati, OH (US)

(72) Inventors: Philip Frank SOUTER, Northumberland (GB); Regine LABEQUE, Neder Over Heembeek (BE); Gerardus Johannes STIJNTJES, Tervuren (BE)

(21) Appl. No.: 14/640,043

(22) Filed: Mar. 6, 2015

Related U.S. Application Data
(60) Provisional application No. 61/949,442, filed on Mar. 7, 2014.

(51) Int. Cl. C11D 3/32; B05D 1/02; C11D 17/04

(52) U.S. Cl. CPC C11D 3/32; C11D 17/044; C11D 17/043; B05D 1/02

(57) ABSTRACT

Detergent compositions comprising a pungent agent. Methods of making such detergent compositions.

### FIELD OF THE INVENTION

The present disclosure relates in part to a detergent composition comprising a pungent agent. The invention also relates to a process for making such a detergent composition.

### BACKGROUND OF THE INVENTION

Detergents today are available in a wide variety of forms such as powders, granules, liquids and gels. Unit dose and concentrated (or compact) detergent forms are becoming increasingly popular due to the convenience they offer the consumer on lower weight and, in case of unit dose, simplified dosing. The highly concentrated nature of these forms offers further sustainability advantages, such as reduced shipping costs and environmental impact (e.g. carbon footprint).

It is known in the art to use bittering substances to reduce the likelihood of accidental ingestion of such forms. For example, it is known to coat a unit dose article with Bitrex® (denatonium benzoate) to prevent accidental ingestion. It is also known to add bittering agents to such articles by incorporation of the bittering agents either in the film or by spraying, printing, or powdering onto the film.

While bittering agents can offer an effective means to deter ingestion, an alternative novel approach is to use pungent agents. Pungent agents offer potential to be an even more effective deterrent to ingestion by young children. Without wishing to be bound by theory, it is believed that the physiological response of young children to pungent agents may be more significant than their response to bittering agents. Consequently, pungent agents could provide an even stronger deterrent to ingestion.

There is a need, therefore, to provide an efficient means of delivering pungent agents in various detergent forms.

### SUMMARY OF THE INVENTION

The present disclosure relates to a detergent composition comprising a first composition and a pungent agent, where the first composition is selected from the group consisting of a liquid detergent, a granular detergent, or a tablet detergent, and where when the first composition is a granular detergent or a tablet detergent, the first composition is encased in either a water-soluble film or a water-soluble coating.

The present disclosure also relates to a unit dose detergent article comprising a liquid composition and a pungent agent; where the liquid composition comprises from 2% to about 20%, by weight of the liquid composition, of water; where the liquid composition further comprises the pungent agent; where the pungent agent comprises a capsaicinoid; and where the liquid composition is encapsulated in water-soluble film.

The present disclosure also relates to a method of making a detergent composition comprising a first composition and a pungent agent, where the method comprises the step of combining the first agent and the pungent agent.

The present disclosure further relates to a unit dose detergent composition comprising: at least one compartment; a water-soluble film; and a pungent agent. At least one compartment of the unit dose may comprise a liquid composition. The liquid composition may comprise a plasticizing solvent. The water-soluble film may comprise a plasticizing agent.

The present disclosure further relates to a granular or tablet detergent composition comprising: a water-soluble film or a water-soluble coating; and a pungent agent. The water-soluble film or the water-soluble coating may comprise the pungent agent.

The present disclosure further relates to a liquid detergent composition comprising: from about 1% to about 70% by weight of a surfactant system; and a pungent agent.

### DETAILED DESCRIPTION OF THE INVENTION

The present disclosure relates to detergent compositions that comprise a pungent agent. The pungent agent is intended to act as a deterrent to ingestion. Pungent agents may be particularly useful as an alternative to, or in combination with, bittering agents, such as Bitrex® (denatonium benzoate).

The present disclosure relates to providing an efficient means of delivering pungent agents to various detergent forms. The pungent agent may be added in several ways:
(a) adding a pungent agent directly to a liquid detergent;
(b) adding a pungent agent directly to a unit dose composition in a liquid phase and inducing said pungent agent to migrate to the surface of the film through choice of an appropriate liquid detergent and an appropriate film;
(c) adding the pungent agent to the outside of the film after the unit dose has been filled with detergent and sealed, where the adding is by means of spraying or atomizing a solution comprising a solvent and said pungent agent;
(d) dusting the pungent agent on the outside of the film of a unit dose where the pungent agent is added as a solid particle, wherein said particle comprises the pungent agent and an inert carrier, said inert carrier preferably selected from the group comprising talc, inorganic salts (particularly sodium sulphate), clays and/or zeolites;
(e) adding the pungent agent to a coating applied to either the tablet or the film of the unit dose; and/or
(f) adding the pungent agent within the film composition, prior to casting or extrusion of said film.

These approaches can solve the technical problem of delivering enough pungent agent to the film to be pungent to the taste. When applying the pungent agent, it is further desired to deliver a quantity sufficient to induce a pungent taste but not in such high quantities that said pungent agent transfers significantly to the hands of a consumer as they add the detergent. Preferred levels of pungent agent are in the range of from about 0.01% to about 1%.

### DEFINITIONS

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting. The phases “comprising” or “comprises” are intended to include the more limiting phrases “consisting essentially of” and “consisting of.” Therefore, a composition that comprises a component may consist essentially of that component, or consist of that component.

As used herein, the terms “substantially free of” or “substantially free from” mean that the indicated material is at the very minimum not deliberately added to the composition to form part of it, or, preferably, is not present at analytically detectable levels. It is meant to include compositions whereby the indicated material is present only as an impurity in one of the other materials deliberately included.

As used herein, the term “soiled material” is used non-specifically and may refer to any type of flexible material consisting of a network of natural or artificial fibers, including natural, artificial, and synthetic fibers, such as, but not limited to, cotton, linen, wool, polyester, nylon, silk, acrylic, and the like, as well as various blends and combinations. Soiled material may further refer to any type of hard surface, including natural, artificial, or synthetic surfaces, such as, but not limited to, tile, granite, grout, glass, composite, vinyl, hardwood, metal, cooking surfaces, plastic, and the like, as well as blends and combinations.

In this description, all concentrations and ratios are on a weight basis of the composition unless otherwise specified.

### Detergent Composition

As used herein, the phrase “detergent composition” includes compositions and formulations designed for cleaning soiled material. Such compositions include, but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation. The detergent compositions may have a form selected from liquid, powder, single-phase or multi-phase unit dose articles, pouch, tablet, gel, paste, bar, or flake.

In some aspects, the detergent composition comprises a first composition where the first composition is selected from the group consisting of a liquid detergent, a granular detergent, or a tablet detergent. Preferably, when the first composition is a granular detergent or a tablet detergent, the first composition is encased in either a water-soluble film or a water-soluble coating.

Liquid detergent compositions and other forms of detergent compositions that include a liquid component (such as liquid-containing unit dose detergent compositions) may contain water and other solvents as fillers or carriers. Low molecular weight primary or secondary alcohols exemplified by methanol, ethanol, propanol, and isopropanol are suitable. Monohydric alcohols may be used in some examples for solubilizing surfactants, and polyols such as those containing from 2 to about 6 carbon atoms and from 2 to about 6 hydroxy groups (e.g., 1,3-propanediol, ethylene glycol, glycerine, and 1,2-propanediol) may also be used. Amine-containing solvents may also be used. Solvents particularly useful in unit dose articles are described below.

The detergent compositions may contain from about 5% to about 90%, and in some examples, from about 10% to about 50%, by weight of the composition, of such carriers. For compact or super-compact heavy duty liquid or other forms of detergent compositions, the use of water may be lower than about 40% by weight of the composition, or lower than about 20%, or lower than about 5%, or less than about 4% free water, or less than about 3% free water, or less than about 2% free water, or substantially free of free water (i.e., anhydrous).

The liquid detergent compositions may comprise water. However, when the liquid composition will be in contact with water-soluble film, for example in a unit dose article, it is typically desirable to limit the amount of water so as to preserve the film's integrity and to prevent a tacky feel to the pouches. Therefore, in some embodiments, the liquid detergent composition comprises less than about 50% water by weight of the liquid composition, or less than about 40% water by weight of the liquid composition, or from about 1% to about 30%, or preferably from about 2% to about 20%, or from about 5% to about 13%, water by weight of the liquid composition.

For powder or bar detergent compositions, or forms that include a solid or powder component (such as powder-containing unit dose detergent composition), suitable fillers may include, but are not limited to, sodium sulfate, sodium chloride, clay, or other inert solid ingredients. Fillers may also include biomass or decolorized biomass. Fillers in granular, bar, or other solid detergent compositions may comprise less than about 80% by weight of the detergent composition, and in some examples, less than about 50% by weight of the detergent composition. Compact or supercompact powder or solid detergent compositions may comprise less than about 40% filler by weight of the detergent composition, or less than about 20%, or less than about 10%.

For either compacted or supercompacted liquid or powder detergent compositions, or other forms, the level of liquid or solid filler in the product may be reduced, such that either the same amount of active chemistry is delivered to the wash liquor as compared to noncompacted detergent compositions, or in some examples, the detergent composition is more efficient such that less active chemistry is delivered to the wash liquor as compared to noncompacted compositions. For example, the wash liquor may be formed by contacting the detergent composition to water in such an amount so that the concentration of detergent composition in the wash liquor is from above 0 g/l to 4 g/l. In some examples, the concentration may be from about 1 g/l to about 3.5 g/l, or to about 3.0 g/l, or to about 2.5 g/l, or to about 2.0 g/l, or to about 1.5 g/l, or from about 0 g/l to about 1.0 g/l, or from about 0 g/l to about 0.5 g/l. These dosages are not intended to be limiting, and other dosages may be used that will be apparent to those of ordinary skill in the art.

In some aspects, the detergent composition is in the form of a unit dose article. The unit dose article comprises at least one compartment, wherein the compartment comprises a composition, for example the first composition. A unit dose article is intended to provide a single, easy to use dose of the composition contained within the article for a particular application. In some aspects, the detergent composition is in unit dose form and comprises water-soluble film that encapsulates the liquid detergent.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The seal region may comprise a flange. The flange is comprised of excess sealed film material that protrudes beyond the edge of the unit dose article and provides increased surface area for seal of the first and second films. The film is described in more detail below. In some aspects, the unit dose article comprises three films.

The unit dose article may comprise more than one compartment, even at least two compartments, or even at least three compartments. In some aspects, the unit dose article comprises 1, or 2, or 3, or 4, or 5 compartments. The compartments may be arranged in superposed orientation, i.e., one positioned on top of the other, where they may share a common wall. In one aspect, at least one compartment is superposed on another compartment. Alternatively, the compartments may be positioned in a side-by-side orientation, i.e., one orientated next to the other. The compartments may even be orientated in a ‘tire and rim’ arrangement, i.e., a first compartment is positioned next to a second compartment, but the first compartment at least partially surrounds the second compartment, but does not completely enclose the second compartment. Alternatively, one compartment may be completely enclosed within another compartment.

When the unit dose article comprises at least two compartments, one of the compartments may be smaller than the other compartment. When the unit dose article comprises at least three compartments, two of the compartments may be smaller than the third compartment, and preferably the smaller compartments are superposed on the larger compartment. The smaller superposed compartments preferably are orientated side-by-side.

When the unit dose article comprises at least two compartments, each compartment may comprise identical compositions, or each compartment may independently comprise a different composition. The compartments may be sensorially different; for example, the compartments may have different shapes, or they may be different colors.

The encapsulated compositions may be any suitable composition. The composition may be in the form of a solid, a liquid, a dispersion, a gel, a paste, or a mixture thereof. The compositions in each compartment of a multicompartment unit dose article may be different. However, typically at least one compartment of the unit dose article, preferably each compartment, comprises a liquid. The composition is described in more detail below.

### Water-Soluble or Water-Dispersible Film

In some aspects, the detergent composition of the present disclosure comprises water-soluble or water-dispersible film. The film may encapsulate the detergent composition, preferably the first composition. The film may encapsulate a liquid composition, a granular detergent, a tablet detergent, or mixtures thereof.

The film of the present invention is soluble or dispersible in water. The water-soluble film preferably has a thickness of from about 20 to about 150 microns, preferably about 35 to about 125 microns, even more preferably about 50 to about 110 microns, most preferably about 76 microns.

Preferably, the film has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion, or blown extrusion of the polymeric material, as known in the art. Preferably the film is obtained by an extrusion process or by a casting process.

Preferred polymers (including copolymers, terpolymers, or derivatives thereof) suitable for use as film material are selected from polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the polymers of the film material are free of carboxylate groups.

Preferably, the level of polymer in the film material, for example a PVA polymer, is at least 60%. The polymer can have any weight average molecular weight, preferably from about 1000 to 1,000,000, more preferably from about 10,000 to 300,000, yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, preferably about 20,000, and of PVA or copolymer thereof, with a weight average molecular weight of about 100,000 to about 300,000, preferably about 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers, preferably polyvinyl alcohol, which are from about 60% to about 99% hydrolysed, preferably from about 80% to about 99% hydrolysed, even more preferably from about 80% to about 90% hydrolysed, to improve the dissolution characteristics of the material.

Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured, by the method set out here after using a glass-filter with a maximum pore size of 20 microns, described above. Water-solubility may be determined at 24° C., or preferably at 10° C.

Preferred films are those supplied by Monosol (Merrillville, Ind., USA) under the trade references M8630, M8900, M8779, and M8310 films described in U.S. Pat. No. 6,166,117 and U.S. Pat. No. 6,787,512, and PVA films of corresponding solubility and deformability characteristics. Other suitable films may include called Solublon® PT, Solublon® GA, Solublon® KC or Solublon® KL from the Aicello Chemical Europe GmbH, the films VF-HP by Kuraray, or the films by Nippon Gohsei, such as Hi Selon. Further preferred films are those described in US2006/0213801, US2011/0188784, WO2010/119022, and U.S. Pat. No. 6,787,512. In some aspects, the film is selected so that the migration of the pungent agent from the liquid to the film occurs at a greater rate than the migration of the pungent agent to M8630 film under otherwise identical conditions. In some aspects, it is preferable to use a film that exhibits better dissolution than M8630 film, supplied by Monosol, at temperatures 24° C., even more preferably at 10° C. Migration and/or presence of the pungent agent on the surface of the film may be determined according to the methods described below.

Preferred water soluble films are those derived from a resin that comprises a blend of polymers, preferably wherein at least one polymer in the blend is polyvinyl alcohol. Preferably, the water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

Different film material and/or films of different thickness may be employed in making the compartments of the present invention. A benefit in selecting different films is that the resulting compartments may exhibit different solubility or release characteristics.

The film material herein can also comprise one or more additive ingredients. For example, the film preferably comprises a plasticizing agent. The plasticizing agent may comprise water, glycerol, ethylene glycol, diethylene glycol, propylene glycol, sorbitol, or mixtures thereof. In some aspects, the film comprises from about 2% to about 35%, or from about 5% to about 25%, by weight of the film, a plasticizing agent selected from group comprising water, glycerol, diethylene glycol, sorbitol, and mixtures thereof. In some aspects, the film material comprises at least two, or preferably at least three, plasticizing agents. In some aspects, the film is substantially free of ethanol, meaning that the film comprises from 0% (including 0%) to about 0.1% ethanol by weight of the film. In some aspects, the plasticizing agents are the same as the plasticizing solvents in the liquid composition, described below.

Other additives may include water and functional detergent additives, including surfactant, to be delivered to the wash water, for example, organic polymeric dispersants, etc.

### Pungent Agent

The detergent composition comprises a pungent agent.

In some aspects, the pungent agent is selected from: capsicinoids (including capsaicin); vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-methoxy-4′-hydroxy-phenyl)-1,3-dioxolane; pepper oil; pepper oleoresin; ginger oleoresin; nonylic acid vanillylamide; jamboo oleoresin; Zanthoxylum piperitum peel extract; sanshool; sanshoamide; black pepper extract; chavicine; piperine; spilanthol; and mixtures thereof. Other suitable pungents agents include polygodial, Tasmannia lanceolata extract, Capsicum extracts, or mixtures thereof.

Preferred pungent agents include capsaicinoids, which includes capsaicin, dihydrocapsaicin, nordihydrocapsaicin, homodihydrocapsaicin, homocapsaicin, and nonivamide. A particularly preferred pungent agent is capsaicin.

Suitable pungent agents may include commercially available agents, such as OPTAHEAT (Symise Flavors), HOTACT (Lipo Chemicals), and HEATENOL (Sensient Flavors).

The detergent composition may comprise from about 0.0001% to about 10%, or from about 0.001% to about 2%, or from about 0.01% to about 1%, or from about 0.1% to about 0.5%, by weight of the detergent composition, of pungent agent. In some aspects, the detergent composition comprises a pungent agent in a sufficient amount to provide a pungent taste. In some aspects, the amount and/or type of pungent agent is selected so as to deliver a controlled level of pungency to a user—e.g., enough to deter ingestion but not so much as to make one physically ill or to accidentally transfer significant amounts to a user's hands or soiled material.

The first composition, preferably a liquid composition, may comprise the pungent agent. When the liquid composition is encapsulated by water-soluble film, the liquid composition may comprise plasticizing solvents selected to induce the pungent agent to migrate into and through the film; the film may also be selected to induce such migration. In some aspects, the pungent agent is not initially present in the film at the time of manufacture of a unit dose article but migrates into the film and to the surface of the film after storage.

When the detergent composition comprises water-soluble film, the water-soluble film may comprise the pungent agent, meaning that the pungent agent may be an integral part of the film and/or in contact with an exterior surface of the film. The pungent agent may be added to the film-forming polymeric material prior forming the film, for example prior to extruding or casting the film. The pungent agent may be on an exterior surface of the water-soluble film, where an interior surface is in contact with the first composition. The pungent agent may be applied to the exterior surface of the film by any suitable means. For example, the pungent agent may be applied to the exterior of the film by dusting, powdering, coating, painting, printing, spraying, atomizing, or mixtures thereof. In some aspects, the pungent agent is applied to the unit dose composition by spraying or atomizing a composition comprising the pungent agent and a plasticizing solvent, which is described below. When the pungent agent is sprayed or atomized onto a film, the sprayed or atomized composition may be non-aqueous, meaning that it comprises less than 20%, or less than 15%, or less than 10%, or less than 5%, or less than 1% water by weight of the sprayed or atomized composition. The sprayed or atomized composition may even comprise zero percent water.

The detergent composition may comprise a coating, where the coating comprises the pungent agent.

In some aspects, the concentration of the pungent agent on the surface of the film is from about 10 ppb to about 10,000 ppm, or preferably from about 50 ppb to about 200 ppm, or more preferably from about 10 ppm to about 250 ppm. In some aspects, the concentration of the pungent agent is determined after storage of the unit dose article for one month at 25° C. and 60% relative humidity.

The pungency of a pungent agent may be determined according to the well-known Scoville Scale and may be reported in Scoville heat units (SHU). In some aspects, the pungent agent may be selected from pungent agents having a pungency level of at least about 1 000 000 SHU, or at least about 5 000 000 SHU, or at least about 10 000 000 SHU, or at least about 15 000 000 SHU. For comparison, the pungency level of capsaicin is about 16 000 000 SHU. Pungency may also be measured by high performance liquid chromatography and determined in American Spice Trade Association (ASTA) pungency units. A measurement of one part capsaicin per million corresponds to about 15 Scoville units, and ASTA pungency units can be multiplied by 15 and reported as Scoville units.

Because it is desirable that the pungent agent be detectable in order to be an effective deterrent, it is generally desirable that the pungency not be masked by other agents, such as cooling agents like menthol and the like. In some aspects, the detergent composition is free of cooling agents, preferably free of menthol.

For similar reasons, it is generally desirable that the pungent agent is readily available to the consumer. Therefore, it is preferred that the pungent agent is not encapsulated separately or isolated from other components of the detergent composition, for example, via capsules or microcapsules. It is understood that encapsulating a first composition comprising the pungency agent in water-soluble film is not considered isolation of the pungent agent in this context, nor does applying the pungent agent to an exterior surface of a water-soluble film. In some aspects, the pungent agent is not in a microcapsule. When present in a microcapsule, the pungent agent will not migrate to the surface of the film.

### Detergent Adjuncts

In addition to the pungent agent discussed above, the detergent composition may comprise other suitable adjuncts.

### Bittering Agent

The detergent composition, which may include water-soluble film encapsulating a detergent composition, may include a bittering agent. Bittering agents may include denatonium salt or derivative thereof, such as denatonium benzoate (commercially available as BITREX®). A combination of pungent agent and bittering agent may be beneficial, as certain segments of a population may not find one taste or the other to be unpleasant.

### Plasticizing Solvent

When the detergent composition comprises a liquid composition encapsulated by a water-soluble film, the liquid composition preferably comprises a plasticizing solvent. The liquid composition may comprise from about 10% to about 50%, or from about 15% to about 40%, by weight of the liquid composition, of the plasticizing solvent.

When the liquid composition comprises both a pungent agent and a plasticizing solvent, the plasticizing solvent is preferably selected to induce the pungent agent to migrate from the liquid composition to the water-soluble film. The liquid composition may consist essentially of the pungent agent and the plasticizing solvent, or the liquid composition may comprise other adjuncts, which are described in more detail below.

The plasticizing solvent in the present compositions can be a plasticizing solvent containing water, organic solvent, or mixtures thereof. Suitable organic solvents include low molecular weight alcohols and/or low molecular weight glycols, wherein “low molecular weight” in this context means having a molecular weight of less than about 500. Suitable organic solvents preferably include glycerol, 1,2-propanediol, 1,3-propanediol, dipropylene glycol, diethylene glycol, sorbitol, and mixtures thereof. In some aspects, the plasticizing solvent comprises water, glycerol, 1,2-propanediol, 1-3-propanediol, dipropylene glycol, diethylene glycol, sorbitol, or mixtures thereof.

In some aspects, the plasticizing solvent comprises at least one primary solvent, preferably an organic solvent, having Hansen solubility (δ) of greater than 29, more preferably greater than 30, and preferably less than 40. For reference, the Hansen solubility for water is approximate 42.

Without wishing to be bound by theory, it is believed that solvents with relatively higher Hansen solubility values tend to migrate through water soluble film at greater rates and levels than solvents with relatively lower Hansen solubility values. Such solvents, then, induce migration of components from the liquid into and through the film. As a unit dose manufacturer generally seeks to minimize migration through film, it is thus counter-intuitive to select a solvent with relatively high Hansen solubility, for example, greater than 29.

The Hansen solubility parameter is a well known and calculated parameter based on a three component measuring system. The Hansen solubility parameter is based on a dispersion force component (δ_{d}), a hydrogen bonding component (δₕ), and a polar component (δₚ). The Hansen solubility parameter (δ) is derived from the fact that the total cohesive energy, which is the energy required to break all the cohesive bonds, is the combination of the dispersion forces (d), the molecular dipole forces (p) and the hydrogen bonding forces (h) according to the following equation:

δ²=δ_{d}²+δₚ²+δₙ²

The Hansen solubility (δ) is calculated by finding the square root of δ².

Dispersion forces are weak attractive forces between non-polar molecules. The magnitude of these forces depends on the polarizability of the molecule, and the dispersion force component (δ_{d}) typically increases with increasing volume (and size) of the molecule, all other properties being roughly equal. Hansen solubility parameters are calculated at 25° C., with ChemSW's molecular modeling Pro v6.1.9 software package which uses an unpublished proprietary algorithm that is based on values published in the Handbook of solubility Parameters and other parameters by Allan F M Barton (CRC Press 1983) for solvents obtained experimentally by Hansen.

The primary solvent preferably has a cLog P of less than −1.0 and more preferably less than −1.5. The primary solvent preferably has a Hydrogen bonding component (δₕ) of greater than 20.5, more preferably greater than 23, and preferably less than 40. For reference, the Hansen solubility for water is approximately 42. The units used are MPa^{0.5}.

The primary solvent is preferably selected from the group consisting of propanediol, glycerol, sorbitol, and mixtures thereof.

Table 1 shows the Hansen Solubility components of the preferred primary solvents and some comparative solvents falling outside of the scope of the preferred primary solvents.

TABLE 1
Hansen solubility component parameters

| | δ Dis- | δ Po- | δ H- | | cLog |
|---|---|---|---|---|---|
| Solvent | persion | larity | bonding | δ | P |
| PEG 200 | 16.54 | 11.22 | 20.91 | 28.9 | −1.47 |
| PEG 300 | 16.23 | 10.09 | 20.17 | 27.8 | −1.22 |
| PEG 400 | 15.81 | 8.21 | 19.12 | 26.1 | −0.7 |
| PEG 600 | 18.98 | 11.22 | 20.91 | 28.9 | −0.74 |
| DPG | 16.67 | 10.86 | 20.35 | 28.5 | −0.6 |
| Propane diol | 16.41 | 10.82 | 23.07 | 30.3 | −1.1 |
| Glycerol | 17.29 | 12.22 | 27.34 | 34.6 | −1.94 |
| Sorbitol | 19.24 | 11.5 | 23.4 | 32.4 | −2.54 |
| nBPP | 15.99 | 5.42 | 8.91 | 19.1 | +1.99 |

In a preferred embodiment, the plasticizing solvent also comprises a secondary solvent, which is preferably an organic solvent. The secondary solvent preferably has Hansen solubility of 28.5 or less. In a further preferred embodiment the ratio of primary solvent to secondary solvent is from 7:1 to 1:5, more preferably from 6.5:1 to 1:3, most preferably 3:1 to 1:1.

In a particularly preferred embodiment, the plasticizing solvent comprises at least a primary solvent, a secondary solvent, and water.

In some aspects, the plasticizing solvent comprises at least two, or preferably at least three organic solvents. In some aspects, the liquid composition is substantially free of ethanol, meaning that the liquid composition comprises from 0% (including 0%) to about 0.1% ethanol by weight of the liquid composition.

The liquid composition may comprise water. However, because the liquid composition will be in contact with water-soluble film, it is typically desirable to limit the amount of water so as to preserve the film's integrity and to prevent a tacky feel to the pouches. Therefore, in some embodiments, the liquid composition comprises less than about 40% water by weight of the liquid composition, or from about 1% to about 30%, or preferably from about 2% to about 20%, or from about 5% to about 13%, water by weight of the liquid composition.

In some aspects, at least two of the organic solvents of the plasticizing solvent are the same as at least two of the plasticizing agents of the film material. In some aspects, the plasticizing solvent is selected to induce said pungent agent to migrate from said liquid composition to said water-soluble film. In order to induce migration, the concentration of plasticizing solvent in the liquid composition and the concentration of plasticizing agents in the film are typically different, preferably different at the time of manufacture.

### Other Adjuncts

The detergent compositions described herein may comprise other adjuncts. Adjuncts may be selected according to the detergent composition's intended function. The first composition may comprise an adjunct. In some aspects, in the case of multi-compartment unit dose articles, the adjuncts may be part of a non-first (e.g., second, third, fourth, etc.) composition encapsulated in compartments separate from the first composition. The non-first composition may be any suitable composition. The non-first composition may be in the form of a solid, a liquid, a dispersion, a gel, a paste or a mixture thereof. Similarly, the adjuncts may be encapsulated in the same compartment as the pungent agent, or the adjuncts, or at least some adjuncts, may be separated from the pungent agent. Where the unit dose comprises multiple compartments, the pungent agent may be added to or present in one, two, or even all the compartments.

Non-limiting examples of detergent compositions include cleaning compositions, fabric care compositions and hard surface cleaners. More particularly, the compositions may be a laundry, fabric care or dish washing composition including, pre-treatment or soaking compositions and other rinse additive compositions. The composition may be a fabric detergent composition or an automatic dish washing composition. The fabric detergent composition may be used during the main wash process or could be used as pre-treatment or soaking compositions.

Fabric care compositions include fabric detergents, fabric softeners, 2-in-1 detergent and softening, pre-treatment compositions and the like. Fabric care compositions may comprise typical fabric care adjuncts, including surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments and mixtures thereof. The composition may be a laundry detergent composition comprising an adjunct selected from the group comprising a shading dye, surfactant, polymers, perfumes, encapsulated perfume materials, structurant and mixtures thereof.

The composition may be an automatic dish washing composition comprising an adjunct selected from surfactant, builder, sulfonated/carboxylated polymer, silicone suds suppressor, silicate, metal and/or glass care agent, enzyme, bleach, bleach activator, bleach catalyst, source of alkalinity, perfume, dye, solvent, filler and mixtures thereof.

Preferably, the liquid composition comprises a surfactant. Surfactants can be selected from anionic, cationic, zwitterionic, non-ionic, amphoteric or mixtures thereof. Preferably, the unit dose composition comprises anionic surfactant, non-ionic surfactant, or mixtures thereof. The detergent composition, preferably the liquid composition, may comprise from about 1% to about 70%, or from about 3% to about 50%, or from about 5% to about 25%, by weight of a surfactant system.

The anionic surfactant may be selected from linear alkyl benzene sulfonate, alkyl ethoxylate sulphate and combinations thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. In one aspect, R¹ is an alkyl group, which may be primary or secondary, that comprises from about 9 to 15 carbon atoms, or from about 10 to 14 carbon atoms. In one aspect, the alkoxylated fatty alcohols will also be ethoxylated materials that contain from about 2 to 12 ethylene oxide moieties per molecule, or from about 3 to 10 ethylene oxide moieties per molecule.

The shading dyes employed in the present laundry care compositions may comprise polymeric or non-polymeric dyes, pigments, or mixtures thereof. Preferably the shading dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred.

The shading dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present disclosure, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

The dye may be introduced into the detergent composition in the form of the unpurified mixture that is the direct result of an organic synthesis route. In addition to the dye polymer therefore, there may also be present minor amounts of un-reacted starting materials, products of side reactions and mixtures of the dye polymers comprising different chain lengths of the repeating units, as would be expected to result from any polymerisation step.

The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

The compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the cleaning composition.

The composition may comprise a brightener. Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein. Suitable chelants include a chelant selected from the group consisting of DTPA (Diethylene triamine pentaacetic acid), HEDP (Hydroxyethane diphosphonic acid), DTPMP (Diethylene triamine penta(methylene phosphonic acid)), ethylenediaminedisuccinic acid (EDDS), 1,2-Dihydroxybenzene-3,5-disulfonic acid disodium salt hydrate, and derivatives of such chelants.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The compositions of the present disclosure may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

The composition may comprise one or more polymers. Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other suitable cellulosic polymers may have a degree of substitution (DS) of from 0.01 to 0.99 and a degree of blockiness (DB) such that either DS+DB is of at least 1.00 or DB+2DS-DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose.

Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Suitable suds suppressors include silicone and/or fatty acid such as stearic acid.

### Process for Washing

The present disclosure also relates to a process for the washing, for example by machine, of laundry or dishware using a composition according to the present disclosure, comprising the steps of, placing a detergent composition according to the present disclosure into contact with the laundry or dishware to be washed, and carrying out a washing or cleaning operation.

Any suitable washing machine may be used. Those skilled in the art will recognize suitable machines for the relevant wash operation. The article of the present invention may be used in combination with other compositions, such as fabric additives, fabric softeners, rinse aids, and the like.

Additionally, the detergent compositions of the present disclosure may be used in known hand washing methods.

### Process for Making

The present disclosure relates to a method of making a detergent composition. More specifically, the present disclosure relates to a method of making a detergent composition comprising a first composition and a pungent agent, where the method comprises the step of combining the first agent and the pungent agent. The combining step may comprise adding said pungent agent directly to the first composition. The combining step may be according to any suitable method of making a detergent composition known to one of ordinary skill, for example in a batch process or in a continuous loop process.

Where the first composition is a granular detergent or a tablet detergent, the method comprises the step of encasing the first composition in encased in either a water-soluble film or a water-soluble coating. Alternatively, the method may comprise the step of providing the first composition already encased in either a water-soluble film or a water-soluble coating.

In some aspects, the method comprises the step of encapsulating said first composition in water-soluble film. The combining step may comprise the step of adding the pungent agent to the film. The adding step may comprise dusting, coating, painting, printing, spraying, atomizing, or mixtures thereof said pungent agent onto said film.

In some aspects, the present disclosure relates to a method of making a unit dose article, where the method comprises the steps of providing a liquid composition comprising a pungent agent and a plasticizing solvent, and contacting a water-soluble film with the liquid composition, wherein the film comprises a plasticizing agent. Adding a pungent agent directly to a unit dose composition in a liquid phase and choosing an appropriate liquid detergent and an appropriate film can induce the pungent agent to migrate to the surface of the film.

In some aspects, the present disclosure relates to making a film comprising a pungent agent, wherein the method comprises the steps of providing a liquid composition comprising a pungent agent and a plasticizing solvent, and contacting a water-soluble film with the liquid composition, wherein the film comprises a plasticizing agent. The film may be formed into a pouch and sealed, thereby forming a sealed pouch. In some aspects, the sealed pouch encapsulates surfactant. In some aspects, the contacting results from filling the pouch with the liquid composition. In some aspects, the contacting results from spraying or atomizing said liquid composition onto said film. The film may be formed into a pouch after the spraying or atomizing.

Preferably, the film is free of pungent agent at the time of manufacture of the film. In some aspects, the film is free of pungent agent at the time of manufacture of the unit dose article.

In some aspects, the combining steps comprises dusting the pungent agent on the outside of the film of a unit dose where the pungent agent is added as a solid particle, where the particle comprises the pungent agent and an inert carrier, the inert carrier preferably selected from the group comprising talc, inorganic salts (particularly sodium sulphate), clays, and/or zeolites.

In some aspects, the pungent agent may be added to the film composition prior to casting or extrusion of the film.

Detergent composition components, including films, pungency agents, and detergent adjuncts, useful to the methods disclosed herein are described above. In some aspects, the pungent agent is selected from: capsicinoids (including capsaicin); vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-methoxy-4′-hydroxy-phenyl)-1,3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof. Preferred pungent agents include capsaicinoids, which includes capsaicin, dihydrocapsaicin, nordihydrocapsaicin, homodihydrocapsaicin, homocapsaicin, and nonivamide. A particularly preferred pungent agent is capsaicin.

The method of making unit dose articles is described in more detail below.

The process of the present disclosure may be continuous or intermittent. The process comprises the general steps of forming an open pouch, preferably by forming a water-soluble film into a mould to form said open pouch, filling the open pouch with a composition, closing the open pouch filled with a composition, preferably using a second water-soluble film to form the unit dose article. The second film may also comprise compartments, which may or may not comprise compositions. Alternatively, the second film may be a second closed pouch containing one or more compartments, used to close the open pouch. Preferably, the process is one in which a web of unit dose article are made, said web is then cut to form individual unit dose articles.

Alternatively, the first film may be formed into an open pouch comprising more than one compartment. In which case, the compartments formed from the first pouch may are in a side-by-side or ‘tire and rim’ orientation. The second film may also comprise compartments, which may or may not comprise compositions. Alternatively, the second film may be a second closed pouch used to close the multicompartment open pouch.

The unit dose article may be made by thermoforming, vacuum-forming or a combination thereof. Unit dose articles may be sealed using any sealing method known in the art. Suitable sealing methods may include heat sealing, solvent sealing, pressure sealing, ultrasonic sealing, pressure sealing, laser sealing or a combination thereof. Examples of continuous in-line processes of manufacturing water-soluble containers are set forth in U.S. Pat. No. 7,125,828, U.S. 2009/0199877A1, EP 2380965, EP 2380966, U.S. Pat. No. 7,127,874 and US2007/0241022 (all to Procter & Gamble Company, Ohio, USA). Examples of non-continuous in-line processes of manufacturing water-soluble containers are set forth in U.S. Pat. No. 7,797,912 (to Reckitt Benckiser, Berkshire, GB).

The unit dose articles may be dusted with a dusting agent. Dusting agents can include talc, silica, zeolite, carbonate or mixtures thereof.

An exemplary means of making the unit dose article of the present disclosure is a continuous process for making an article, comprising the steps of:

a. continuously feeding a first water-soluble film onto a horizontal portion of an continuously and rotatably moving endless surface, which comprises a plurality of moulds, or onto a non-horizontal portion thereof and continuously moving the film to said horizontal portion;
b. forming from the film on the horizontal portion of the continuously moving surface, and in the moulds on the surface, a continuously moving, horizontally positioned web of open pouches;
c. filling the continuously moving, horizontally positioned web of open pouches with a product, to obtain a horizontally positioned web of open, filled pouches;
d. preferably continuously, closing the web of open pouches, to obtain closed pouches, preferably by feeding a second water-soluble film onto the horizontally positioned web of open, filed pouches, to obtain closed pouches; and
e. optionally sealing the closed pouches to obtain a web of closed pouches.

The second water-soluble film may comprise at least one open or closed compartment.

In one embodiment, a first web of open pouches is combined with a second web of closed pouches preferably wherein the first and second webs are brought together and sealed together via a suitable means, and preferably wherein the second web is a rotating drum set-up. In such a set-up, pouches are filled at the top of the drum and preferably sealed afterwards with a layer of film, the closed pouches come down to meet the first web of pouches, preferably open pouches, formed preferably on a horizontal forming surface. It has been found especially suitable to place the rotating drum unit above the horizontal forming surface unit.

Preferably, the resultant web of closed pouches is cut to produce individual unit dose articles.

### Test Methods

The migration and/or presence of the pungent agent may be measured in the following way(s). A unit dose article comprising film may be provided, where the unit dose article did not initially have a pungent agent on the exterior of the film. The amount of weeping (i.e., liquids traveling through the film) can be quantified according to the method below. The presence of the pungent agent can also be determined according to the method below. As the pungent agent migrates with the liquid through the film, it follows that more weeping indicates more migration of the pungent agent. As described above, careful selection of plasticizing solvents and/or films can lead to increased migration of the pungent agent.

### Method for Measuring Weeping

Migration of liquid compounds through the film to the outside of the water soluble package can be quantified using a Corneometer CM825 equipped with CM-825 probe, manufactured by Courage-Khazaka Electronic, Koln, Germany. The equipment is calibrated according to the supplier recommendation. The equipment provides a corneometer value which is recorded. The Corneometer can detect even slightest changes in weeping level since change in the dielectric constant (i.e. presence of fluid on the outside of the pouch) alters the Corneometer value.

The equipment is placed in a conditioned laboratory at 20° C.+/−3 C and 50%+/−10 relative humidity. The pouches are brought to temperature of 20+/−3 C prior to the measurement. The probe is cleaned with a dry and clean paper tissue; then blank measurements are made by slowly wiping the sensor on the clean paper tissue (VWR International bvba, Leuven, Belgium, Cat. No. 115-0600), to ensure there is no contamination on the probe, until the instrument reads a Corneometer value of zero. The probe is placed vertically on the pouch, as per the usage instructions. Ten replicates are measured for each pouch. The center and corners of the top and bottom face of the pouch are tested. Measurements are repeated on 5 different pouches. The data is thus the average of 50 measurements. The probe is cleaned in between each measurement.

The following table provides an interpretation of the corneometer value for weeping.

| Weeping classification | Corneometer value |
|---|---|
| Extremely light | <50 |
| Very light | 50-59 |
| Light | 60-64 |
| Light/Medium | 65-59 |
| Medium | 70-74 |
| Medium/Heavy | 75-79 |
| Heavy | 80-84 |
| Very heavy | 85-89 |
| Extremely heavy | >90 |

### Method for Measuring Presence/Migration of Pungent Agent

To determine the presence and/or amount of pungent agent present on the surface of the film, sensory or analytical techniques may be employed. A suitable sensory technique (e.g., via taste in controlled circumstances) is disclosed in WO2014/026855 A1, assigned to Henkel AG & Co., and can be adapted for pungent agents by one of skill in the art.

The pungent agent may be extracted from the surface via the following method. The unit dose pouch is held with tweezers at the seal. The surface of the each side of the pouch is rinsed 10 times, with 4 to 5 mL of methanol used in each rinse cycle and collected. After rinsing, the methanol solution is transferred to a glass vial, and the methanol is evaporated. The remaining extract is then dissolved in the appropriate solvent needed for the analytical method.

Pungent agents can be assayed via standard methods known to those skilled in the art. Analytical techniques may include chromatography or spectroscopic techniques known to one skilled in the art. For example, a suitable technique using high performance liquid chromatography (HPLC) is described in Musfiroh et al., Int J Pharm Pharm Sci, Vol 5, Issue 1, 248-251 (2013).

### EXAMPLES

In the non-limiting examples below, all levels are in weight percent of the composition unless noted otherwise.

### Example 1

### Film Comprising Capsaicin

### Sample Preparation:

Natural capsaicin (65% of capsaicin and 35% of dihydrocapsaicin) obtained from Sigma Aldrich was diluted as a 1% solution in ethanol. 2 ml of the 1% capsaicin solution were sprayed onto the surface of a water-soluble polyvinyl alcohol film supplied by MonoSol (sprayed surface=11 cm×30 cm) using an airbrush (IWATA® NEO) at a working distance of about 10 cm and with a working pressure of about 25 psi (corresponding to about 1.7 bar). The film is suitable for making unit dose detergent pouches.

### Test Panel:

Twenty-five adult subjects were given a 2 cm×5 cm piece of coated film. The subjects were asked to lick the film and give a signal as soon as they could detect an unpleasant taste. The timer was started at the moment the consumer licked the film, and stopped the moment the consumer gave the signal. This time was recorded as the response time (s). Subjects were then asked to describe the strength of the (unpleasant) taste on a scale of 1 to 5 (1 being mild, 5 being unbearable). Subjects rating the strength of the test as 3, 4, or 5 were counted as “tasters.” The results are summarized in Table 1.

TABLE 1

| | |
|---|---|
| Average Response Time | 3.8 seconds |
| 75th Percentile Response Time | 4.0 seconds |
| Subjects reacting within 6 seconds* | 96% (n = 24) |
| Subjects counting as tasters | 76% (n = 19) |

*For comparison, other investigations have shown that subjects tasting a water-soluble film that has not been treated with an aversive agent (for example, no capsaicin) essentially do not suffer an aversive taste reaction (e.g., no unpleasant reaction within 20 seconds).

### Example 2

### Mono Compartment Pouches

Mono compartment pouches are filled with liquid detergents of composition 2.1, shown in Table 2. The pouches are made using M8779 film, available from Monosol, and formed using standard thermoforming techniques. Specifically, 0.7 g of a 76 μm thick film M8779 are thermoformed to form a single compartment pouch measuring 41 mm by 43 mm. The pouch is filled with 23.7 mL (25.4 g) of composition 2.1.

TABLE 2

| Ingredients | 2.1 |
|---|---|
| Linear C₉-C₁₅ Alkylbenzene sulfonic acid | 20 |
| C₁₂₋₁₄ alkyl 9-ethoxylate | 15 |
| Citric Acid | 1 |
| Fatty acid | 8 |
| C12-14 alkyl ethoxy 3 sulfate | 9 |
| Chelant | 1 |
| Polymer | 7 |
| Enzymes | 1 |
| Structurant | 0.15 |
| Pungent Agent (e.g., capsaicin) | 0.25 |
| Glycerol | 6 |
| 1,2 propanediol | 11 |
| Water | 10 |
| Mono-ethanolamine or NaOH (or mixture | neutralize to pH |
| thereof) | to about 7.4 |
| Additives, Minor | To 100% |

### Example 3

### Multi Compartment Pouches

Examples of multicompartment pouches can include the formulations presented in Table 3. The pouches are made with water-soluble film according to those disclosed in US Patent Application 2011/0188784A1. Pungent agent is applied to the exterior of Example 3.1 by spraying the pouch with a solution of pungent agent and solvent; the sprayed pouch comprises approximately 0.2% pungent agent. The pouch material or contents of Examples 3.1, 3.2, and/or 3.3 may further include a bittering agent, such as BITREX® (denatonium benzoate).

TABLE 3

| | 3.1 | | | 3.2 | | 3.3 | | |
|---|---|---|---|---|---|---|---|---|
| | 3 compartments | | | 2 compartments | | 3 compartments | | |
| Compartment # | 1 | 2 | 3 | 1 | 2 | 1 | 2 | 3 |
| Dosage (g) | 34.0 | 3.5 | 3.5 | 30.0 | 5.0 | 25.0 | 1.5 | 4.0 |
| Ingredients | Weight % | | | | | | | |
| Alkylbenzene sulfonic acid | 20.0 | 20.0 | 20.0 | 10.0 | 20.0 | 20.0 | | |
| Alkyl sulfate | | | | 2.0 | | | | |
| C12-14 alkyl 7-ethoxylate | 17.0 | 17.0 | 17.0 | | 17.0 | 17.0 | | |
| Cationic surfactant | | | | 1.0 | | | | |
| Zeolite A | | | | 10.0 | | | | |
| C12-18 Fatty acid | 13.0 | 13.0 | 13.0 | | 18.0 | 18.0 | | |
| Sodium acetate | | | | 4.0 | | | | |
| Enzymes | 0-3 | 0-3 | 0-3 | 0-3 | | 0-3 | | |
| Sodium Percarbonate | | | | 11.0 | | | | |
| TAED | | | | 4.0 | | | | |
| Organic catalyst ¹ | | | | 1.0 | | | | |
| PAP granule ² | | | | | | | | 50 |
| Polycarboxylate | | | | 1.0 | | | | |
| Ethoxysulfated | 2.2 | 2.2 | 2.2 | | | | | |
| Hexamethylene Diamine | | | | | | | | |
| Dimethyl Quat | | | | | | | | |
| Hydroxyethane | 0.6 | 0.6 | 0.6 | 0.5 | | | | |
| diphosphonic acid | | | | | | | | |
| Ethylene diamine | | | | | | 0.4 | | |
| tetra(methylene phosphonic) | | | | | | | | |
| acid | | | | | | | | |
| Brightener | 0.2 | 0.2 | 0.2 | 0.3 | | 0.3 | | |
| Alkoxylated polyamine ⁶ | 5 | | | | 4 | 7 | | |
| Hueing dye ⁴ | | | 0.05 | | 0.035 | | 0.12 | |
| Perfume | 1.7 | 1.7 | | 0.6 | | 1.5 | | |
| Pungent Agent (e.g., | * | * | * | | 0.1 | 1 | | |
| capsaicin) | | | | | | | | |
| Water | 10.0 | 10.0 | 10.0 | | 4.0 | | | |
| Glycerol | 5 | | | | | 6 | 10 | |
| Sorbitol | | | | | 1 | | | |
| Propane diol | 5 | 5 | 5 | | 30 | 11 | 89 | |

| | |
|---|---|
| Buffers (sodium | To pH 8.0 for liquids |
| carbonate, | To RA >5.0 for powders |
| monoethanolamine) ⁵ | |
| Minors (antioxidant, | To 100% |
| aesthetics, . . . ), sodium | |
| sulfate for powders | |

*Pungent agent is applied to the exterior of Example 2.1 by spraying the pouch with a solution of pungent agent and solvent; the sprayed pouch comprises approximately 0.2% pungent agent by weight of the pouch.
¹ Sulfuric acid mono-[2-(3,4-dihydro-isoquinolin-2-yl)-1-(2-ethyl-hexyloxymethyl)-ethyl]ester as described in U. S. Pat. No. 7,169,744
² PAP = Phthaloyl-Amino-Peroxycaproic acid, as a 70% active wet cake
³ Polyethylenimine (MW = 600) with 20 ethoxylate groups per -NH.
⁴ Ethoxylated thiophene, EO (R₁ + R₂) = 5
⁵ RA = Reserve Alkalinity (g NaOH/dose)
⁶ PEI600 EO20, available from BASF

### Example 4

### Liquid Detergent Compositions

Examples of liquid detergent composition can include the formulations presented in Table 4. Example 4.1 is a typical heavy duty liquid detergent, and Example 4.2 is a typical compact liquid detergent.

TABLE 4

| | 4.1 (wt %) | 4.2 (wt %) |
|---|---|---|
| AES C₁₂₋₁₅ alkyl ethoxy (1.8) sulfate | 10.9 | 16 |
| Alkyl benzene sulfonate ² | 1.56 | 20 |
| Sodium formate | 2.66 | 2.66 |
| Sodium hydroxide | 0.21 | 0.21 |
| Monoethanolamine (MEA) | 1.65 | 1.65 |
| Diethylene glycol (DEG) | 4.10 | 4.10 |
| AE9³ | 0.40 | 0.40 |
| C16AE7 | 3.15 | 8 |
| Pungent Agent (e.g., capsaicin) | 0.3 | 0.2 |
| Chelant⁴ | 0.18 | 0.4 |
| Citric Acid | 1.70 | 1.70 |
| C₁₂₋₁₈ Fatty Acid | 1.47 | 3 |
| Borax | 1.19 | 1.5 |
| Ethoxylated Polyethyleneimine ¹ | 1.35 | 2.5 |
| A compound having the following general | 0.40 | 0.40 |
| structure: bis((C₂H₅O)(C₂H₄O)n)(CH₃)—N⁺— | | |
| CₓH₂ₓ—N⁺—(CH₃)-bis((C₂H₅O)(C₂H₄O)n), | | |
| wherein n = from 20 to 30, and x = from 3 to | | |
| 8, or sulphated or sulphonated variants thereof | | |
| 1,2-Propanediol | 2.40 | 8 |
| Protease (54.5 mg active/g)⁹ | 0.89 | 0.89 |
| Mannanase: Mannaway ® (25.6 mg active/g)⁵ | 0.04 | 0.04 |
| Amylase: Natalase ® (29 mg active/g) | 0.14 | 0.2 |
| Fluorescent Whitening Agents¹⁰ | 0.10 | 0.10 |

| | |
|---|---|
| Water, perfume, dyes & other components | Balance |

¹ Polyethyleneimine (MW = 600) with 20 ethoxylate groups per —NH.
² Linear alkylbenzenesulfonate having an average aliphatic carbon chain length C₁₁-C₁₂ supplied by Stepan, Northfield, Illinois, USA
³AE9 is C₁₂₋₁₃ alcohol ethoxylate, with an average degree of ethoxylation of 9, supplied by Huntsman, Salt Lake City, Utah, USA
⁴Suitable chelants are, for example, diethylenetetraamine pentaacetic acid (DTPA) supplied by Dow Chemical, Midland, Michigan, USA or Hydroxyethane di phosphonate (HEDP) supplied by Solutia, St Louis, Missouri, USA Bagsvaerd, Denmark
⁵Natalase ®, Mannaway ® are all products of Novozymes, Bagsvaerd, Denmark.
6. Proteases may be supplied by Genencor International, Palo Alto, California, USA (e.g. Purafect Prime ®) or by Novozymes, Bagsvaerd, Denmark (e.g. Liquanase ®, Coronase ®).
¹⁰Suitable Fluorescent Whitening Agents are for example, Tinopal ® AMS, Tinopal ® CBS-X, Sulphonated zinc phthalocyanine Ciba Specialty Chemicals, Basel, Switzerland

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising a first composition and a pungent agent,
wherein said first composition is selected from the group consisting of a liquid detergent, a granular detergent, or a tablet detergent, and
wherein when said first composition is a granular detergent or a tablet detergent, said first composition is encased in either a water-soluble film or a water-soluble coating.

2. A detergent composition according to claim 1, wherein said first composition comprises said pungent agent.

3. A detergent composition according to claim 1, wherein said first composition is a granular detergent or a tablet detergent, and said water-soluble film or said water-soluble coating comprises said pungent agent.

4. A detergent composition according to claim 1, wherein said first composition is a liquid detergent.

5. A detergent composition according to claim 4, wherein said liquid detergent comprises said pungent agent.

6. A detergent composition according to claim 4, wherein said liquid detergent comprises less than 50% water.

7. A detergent composition according to claim 1, wherein said detergent composition is in unit dose form, wherein said detergent composition comprises water-soluble film that encapsulates said first composition.

8. A detergent composition according to claim 7, wherein said water-soluble film comprises said pungent agent.

9. A detergent composition according to claim 8, wherein said pungent agent is on an exterior surface of said water-soluble film.

10. A detergent composition according to claim 9, wherein said pungent agent is applied to said exterior surface by dusting, coating, painting, printing, spraying, atomizing, or mixtures thereof.

11. A detergent composition according to claim 1, wherein said pungent agent is selected from capsicinoids; vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-methoxy-4′-hydroxy-phenyl)-1,3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

12. A detergent composition according to claim 11, wherein said pungent agent is a capsaicinoid.

13. A detergent composition according to claim 12, wherein said capsaicinoid comprises capsaicin.

14. A detergent composition according claim 1, wherein said detergent composition comprises from about 0.01% to about 1%, by weight of said detergent composition, said pungent agent.

15. A detergent composition according to claim 1, wherein said detergent composition comprises a pungent agent in a sufficient amount to provide a pungent taste.

16. A unit dose detergent article comprising a liquid composition and a pungent agent; wherein said liquid composition comprises from 2% to about 20% of water; wherein said liquid composition further comprises said pungent agent; wherein said pungent agent comprises a capsaicinoid; and wherein said liquid composition is encapsulated in water-soluble film.

17. A method of making a detergent composition comprising a first composition and a pungent agent, wherein said method comprises the step of combining said first composition and said pungent agent.

18. A method according to claim 17, wherein said combining step comprises adding said pungent agent directly to said first composition.

19. A method according to claim 17, wherein said method further comprises the step of encapsulating said first composition in water-soluble film.

20. A method according to claim 19, wherein said combining step comprises the step of adding said pungent agent to said film.

21. A method according to claim 19, wherein said adding step comprises dusting, coating, painting, printing, spraying, atomizing, or mixtures thereof said pungent agent onto said film.

22. A detergent composition according to claim 1 in the form of a unit dose detergent composition comprising:
a. at least one compartment;
b. a water-soluble film; and
c. said pungent agent.

23. A unit dose detergent composition according to claim 22, wherein said at least one compartment comprises a liquid composition.

24. A unit dose detergent composition according to claim 23, wherein said liquid composition comprises plasticizing solvent.

25. A unit dose detergent composition according to claim 22, wherein said water-soluble film comprises a plasticizing agent.

26. A composition according to claim 5, wherein said first composition further comprises from about 1% to about 70% by weight of a surfactant system.
